(19) United States
(12) Patent Application Publication
(10) Pub. No.: US 2006/0144300 A1
(43) Pub. Date: Jul. 6, 2006

(54) Cement comprising anisotropic polymer particles, cementitious paste, consolidated material, preparation and uses

(75) Inventors: Sylvie Touzet, Antony (FR); Gilles Orange, Soisy sous Montmorency (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: RHODIA CHIMIE

(21) Appl. No.: 11/365,628

(22) Filed: Mar. 2, 2006

Related U.S. Application Data
(62) Division of application No. 10/311,428, filed on Jun. 2, 2003.

(30) Foreign Application Priority Data
Jun. 21, 2000 (FR) 00/07923

(51) Int. Cl. C04B 24/00

(52) U.S. Cl. 106/802

(57) ABSTRACT

A cement is disclosed containing at least a hydraulic binder and anisotropic polymer particles whereof the modulus of elasticity is not more than 10 GPa and whereof the longest dimension ranges on an average between 0.6 and 6 mm. The cement is used in oil and gas extraction.

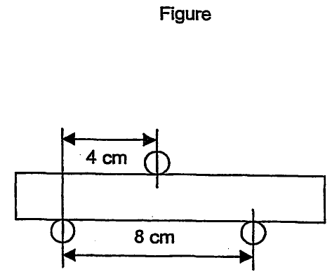

### CROSS REFERENCE TO RELATED APPLICATIONS

This application is a divisional of application Ser. No. 10/311,428, filed Jun. 2, 2003, which was a National stage filing under 35 U.S.C. §371 of International Application No. PCT/FR01/01959, filed Jun. 21, 2001, which in turn claims priority to French Application No. 00/07923, filed Jun. 21, 2000, the disclosures of which are incorporated herein in their entirety.

The present invention relates to a cement comprising at least one hydraulic binder and anisotropic polymer particles, the longest dimension of which is on average between 0.6 and 6 mm. The present invention relates likewise to a cementitious paste and to the corresponding consolidated material, to the production of the cement, the paste and the material and to their uses.

The fields of application of the present invention may be as varied as the building field, the civil engineering field and that of oil or gas field production.

Mention may most particularly be made to the latter field and especially to well cementing operations.

These operations are convention and are carried out during construction of the actual well, generally before it goes into production. The objective of the cementing operations is especially to create a caisson whose purpose is, on the one hand, to support the drills and, on the other hand, to seal the well and give it mechanical strength in order to prevent it from collapsing.

The cementitious paste conventionally used in cementing operations, which comprises a hydraulic binder, admixtures, fillers and water, is pumped and injected between the walls of the formation penetrated and that of a hollow pipe, consequently creating a formwork. The paste is then hardened between these two walls.

The compositions currently employed represent a good compromise between the various characteristics required of such compositions. Thus, they exhibit good rheology, a suitable setting time, an ability to limit, during setting, the rise of gases that could be the cause of heterogeneities in the assembly and therefore of subsequent weakening. They also possess filtrate reducing properties, in other words the ability to prevent undesirable migration of one or more components of the fluid employed during production of the field, for example toward the formation traversed.

However, it has been found that the mechanical properties of these caissons may still be improved, and necessarily so. This is because the operating conditions of these wells are very harsh, whether in terms of temperature or pressure. In addition these stresses may be applied both under static conditions (high temperatures of around 50° C. to 200° C.) or dynamic conditions (thermal cycles). Furthermore, the material of the caisson may also be subjected to mechanical stresses such as impacts (for example impacts by the drillpipes) or ground movements (compressive or flexural stresses). These stresses cause the appearance of cracks in the caisson, consequently reducing its effectiveness.

An additional difficulty is that the improvement in the final properties of the consolidated materials, obtained when the cementitious pastes harden, has to be accomplished without impairing the usage properties of the cementitious paste, and especially without impairing the rheological properties of the paste, which must remain pumpable. The modified compositions must also be stable over time and, for example, not settle between the moment when the water is added and when the composition is injected, and then when it sets. Finally, the setting time must not be significantly modified.

Attempts have been made for some time to solve this problem of how to improve the final mechanical properties of these compositions. One of the solutions proposed has been to add isotropic particles of elastomeric polymers, especially such as those coming from the tire industry so as inter alia to lower the elastic modulus of the consolidated material. One of the obvious economic advantages of this solution lies in the very low cost of these particles, which come essentially, if not completely, from the recycling of tires. However, this solution is not completely satisfactory since the required contents of such particles are relatively high, of around 30% by weight in relation to the weight of binder.

The object of the present invention is therefore to provide a means for improving the mechanical properties of a consolidated material obtained by the hardening of a cementitious paste, more particularly to reduce the elastic modulus (Young's modulus), without significantly impairing the properties required during installation of said paste (rheology, setting time, stability).

These and other objectives are achieved by the present invention, the first subject matter of which is a cement comprising a hydraulic binder, optionally at least one filler, optionally at least one admixture, and anisotropic particles of a polymer having an elastic modulus of less than or equal to 10 GPa, said particles having a size such that the largest dimension is on average between 0.6 and 6 mm and the particle content being less than or equal to 10% by weight in relation to the weight of hydraulic binder.

The subject matter of the invention is also a cementitious paste comprising the cement defined above and water, and a consolidated material obtained by said paste hardening.

In addition, the subject of the present invention is the preparation of a cementitious paste consisting, in a first implementation, in bringing the cement into contact with water, while stirring. In a second implementation, it consists in bringing the binder, optionally the fillers and optionally the admixtures into contact with the water, with stirring and then in adding the anisotropic particles.

Another subject matter of the present invention consists of the use of the cement, of the cementitious paste and of the consolidated material in the field of oil or gas extraction or in the building or civil engineering fields.

It has been found in fact that the use of anisotropic particles of this type, in proportions as low as this, allows the mechanical properties of the consolidated material to be improved.

Completely unexpectedly, the improvement in the mechanical properties of the consolidated material is the more pronounced the higher the temperatures at which the cementitious paste is conditioned, formed and set and the higher the temperatures at which the material obtained is then cured and used.

More specifically, at the temperatures conventionally encountered in oil or gas well production, that is to say of around 50° C. and higher, a reduction in the elastic modulus possibly as much as 20% has been found with only 2% by weight of anisotropic particles, relative to the value of this elastic modulus for a consolidated material containing no anisotropic particles. It is quite remarkable that this level of performance can be achieved with as low a content of anisotropic particles. It should also be noted that the reduction in modulus is not significantly measurable if the anisotropic particles are replaced with the same proportion of isotropic polymeric particles having an average size of between 0.6 and 6 mm, or even of particles of smaller size, for example those with a diameter of between 1 and 600 μm.

However, further features and advantages will become more clearly apparent from reading the description and examining the examples that follow.

As was indicated above, the anisotropic particles incorporated into the cement composition consist of a polymer.

We should point out that this term is to be understood in the broad sense. Thus, it equally denotes both homopolymers and copolymers, or combinations thereof.

More particularly, the polymer has a Young's modulus of less than or equal to 10 GPa, preferably less than or equal to 5 GPa.

In addition, the polymer is chosen from thermoplastic polymers. In other words, said polymers must be able to be formed in the melt state or else in the gel state, without requiring a crosslinking step to be carried out.

According to one particular embodiment of the present invention, the polymer has a glass transition temperature of greater than or equal to 20° C.

Figuring among the polymers suitable for implementing the present invention are those whose melting point is more particularly greater than or equal to 100° C., and preferably greater than or equal to 150° C. It should be pointed out that the temperature value corresponds to that when all of the polymer is in the molten form.

The polymer of which the anisotropic polymers are composed may be hydrophobic, intrinsically hydrophilic or treated so as to make it such.

Purely as an illustration, the polymer may be chemically treated so as to graft the functional groups, such as carboxylic acid, anhydride, alcohol, amine, ethylene oxide, propylene oxide, etc., by themselves or combined.

According to one particularly advantageous embodiment, the polymer employed is chosen from polyethylene, polypropylene, polyvinyl alcohol, polyamide, polyester and their combinations, in the form of homopolymer blends and/or copolymer blends.

Preferably, the anisotropic particles are polyamide-based.

The term “polyamide” is understood to mean polymers comprising at least one of the following units:
—NH—R¹—NHCO—R²—CO— (I),
—NH—R³—CO— (II),
in which formulae R¹, R² and R³, which may or may not be identical, represent:

linear or branched, divalent alkyl radicals containing 2 to 18 carbon atoms,

divalent aryl radicals containing one or more optionally substituted aromatic rings.

According to one particular embodiment of the invention, the radicals R¹, R² and R³, which may or may not be identical, represent linear or branched radicals containing 2 to 12 carbon atoms and preferably methylene radicals optionally carrying one or more methyl radicals.

More particularly, said radicals, which may or may not be identical, are chosen from ethyl, 1-methylethyl, propyl, 1-methylpropyl, butyl, pentyl, hexyl, heptyl, octyl, nonyl, decyl, undecyl and lauryl divalent radicals.

Another possibility consists of radicals R², R′² and R³ which may or may not be identical, that represent aryl radicals containing one or more optionally substituted aromatic rings.

If the aforementioned radicals contain only a single aromatic ring, preferably having 6 carbon atoms, having free bonds in the ortho, meta or para position.

We should point out that, if the afore-mentioned radicals comprise several aromatic rings, preferably two aromatic rings, these may be peri-fused together or linked via inert groups, such as simple valence bonds, an alkyl radical containing 1 to 4 carbon atoms.

Among radicals comprising two aromatic rings, mention may most particularly be made of divalent naphthyl radicals having free bonds on carbon atoms 1 and 2, 1 and 4, 1 and 5, 1 and 6, 1 and 7 and 2 and 7.

A preferred variant of the invention uses, as polyamide units (I) or (II), units making it possible to obtain, in particular, PA-4, PA-6, PA-10, PA-11, PA-12, PA-6,6, PA-4, 6 and PA-6,10 polyamides, and blends or copolymers thereof. Preferably, units are used that make it possible to obtain PA-6 or PA-6,6 polyamides and blends or copolymers thereof.

These polymers comprising units (I) and/or (II) are obtained by carrying out the conventional methods for obtaining polyamides.

Thus, units (I) are obtained by the reaction of at least one diamine with at least one diacid, and units (II) by the reaction of at least amino acid and/or at least one lactam.

The degree of progress of the reaction is controlled in order to obtain a polymer of suitable molecular weight.

It should be noted that the polyamide-type polymers may include units other than those that have just been described. Thus, it would not be outside the scope of the present invention to employ polyamides containing units of the ester type, or else polyoxyalkylene (polyoxyethylene or polyoxypropylene units).

According to another feature of the present invention, the particles incorporated into the cement composition are anisotropic.

More particularly, these particles have a size such that the largest dimension is on average between 0.6 and 6 mm. More particularly, the largest dimension is on average greater than 0.6 mm and less than 6 mm. Preferably, the longest dimension is on average between 1 and 5 mm.

It should be noted that the average dimension is expressed in relation to the number of particles.

Furthermore, the equivalent diameter of the particles is more particularly between 1 and 150 μm. The term “equivalent diameter” refers to the longest dimension of the cross section of the anisotropic particle, this dimension being used to define a circle within which the form of this cross section can be inscribed.

Moreover, the cross section corresponds to the section traversing, approximately at right angles, the plane of largest area of the particle.

It should be noted that the cross section of the anisotropic particle may be circular in shape, but may also be ellipsoidal, multilobate, parallelepipedal or even polyhedral in shape. The geometry of the cross section depends, for example, on the die employed when forming said anisotropic particles by spinning.

Very advantageously, the anisotropic particles are in fiber or ribbon form.

The measurements of the particle sizes are carried out conventionally by optical or electron microscopy, depending on the particle size or dimension measured (length, equivalent diameter).

It should be noted that the particles according to the invention, may come from recycled materials, provided that they have the appropriate structure and the appropriate dimensions.

The content of particles used in the cement is less than or equal to 10% by weight in relation to the weight of hydraulic binder. More particularly, this content is less than or equal to 6% by weight in relation to the weight of hydraulic binder. Preferably, the minimum particle content is 1% in relation to the same reference. According to a highly advantageous variant of the invention, the content of anisotropic particles of the cement represents 1 to 4% by weight in relation to the weight of hydraulic binder.

We should point out that the abovementioned particle content takes into account both the weight of particles and, where appropriate the weight of water with which they are associated. This is because some polymers, especially such as polyamides or polyesters, may absorb a relatively large amount of water without the particles losing their “dry” appearance. To take an example, the water content of polyamide and/or polyester particles may be between 10 and 40% by weight in relation to the weight of polymer.

The cement according to the present invention furthermore includes a hydraulic binder.

All the standard compounds able to react and harden when they are in the presence of water may be used.

Thus, it may be suitable for implementing the invention to use compounds based on silicon, aluminum, calcium, oxygen and/or sulfur. For example, compounds based on calcium silicate (Portland cement), pozzolana, gypsum, hydraulic binders having a high aluminum content, phosphate-based hydraulic binders and calcium-silicate-based hydraulic binders are preferred. Likewise, it would not be outside the scope of the present invention to use hydraulic binders of the phosphorus-magnesium type.

We should point out that the cement according to the invention may include admixtures conventional in the field, such as for example filtrate reducing agents, setting retarders or accelerators, dispersants, antifoams, defoamers, rheology modifiers, thickeners, air entrainers, agents preventing gas migration, etc.

Usually the total content of these admixtures, when they are present, does not exceed 30% by weight of the hydraulic binder.

The cement according to the present invention may furthermore include fillers. As nonlimiting examples of mineral fillers that can be used, mention may be made of calcium carbonate, fly ash, silica, silica fume, clays (kaolin, metakaolin, bentonite, sepiolite, wollastonite), mica, feldspar, silicate, glass, titanium dioxide, aluminum dioxide and magnesia.

As organic filler, it is possible in particular to use expanded polystyrene.

The average size of the mineral particles is advantageously less than or equal to 120 μm, preferably less than or equal to 80 μm.

The content of fillers in the cement, when they are present, varies depending on the subsequent applications of the cement. Likewise, depending on whether it is desired to densify or lighten the cement, mineral or organic fillers may be employed.

Here again, without intending to be limited thereby, the filler content represents at most the same weight as the hydraulic binder.

Another subject matter of the invention consists of a cementitious paste comprising the abovementioned cement and water.

The water employed may come from various sources. Thus, it is possible to use the water present on the drilling or construction site (called water of formation) provided that the content of compounds that it contains, such as essentially salts, does not interact contrarily with the other constituents of the cement of the cementitious paste or of the consolidated material.

Everything indicated above regarding the nature and the quantity of the constituent elements of the cement remains valid and will not be repeated here.

As regards the water content, this may be easily determined by a person skilled in the art. It depends inter alia on the desired rheology and density characteristics of the cementitious paste.

The subject matter of the present invention is also the preparation of the cementitious paste.

According to a first method, the cement and water are bought into contact with each other, with stirring.

According to a second method, the cementitious paste is obtained by bringing the hydraulic binder, optionally the filler and optionally the admixture into contact with the water, with stirring, and then the anisotropic particles are added.

In this situation, the particles may be introduced in dry form, that is to say, depending on the nature of the polymer, whether or not in the presence of associated water, or else in the form of a dispersion, more particularly an aqueous dispersion. If the particles are incorporated in the form of a dispersion, the amount of water added before incorporating the particle suspension takes into account the water content in said suspension.

It should be noted that whatever the method used, the amount of water introduced does not take into account the water associated with the polymer, if this water is present.

The blending of the various constituent elements during the preparation of the cementitious paste is conventional in the field. In particular, a mixing operation and, if necessary a deagglomeration operation are carried out.

The mixing operation is generally carried out at room temperature.

Once the contacting step has been carried out, the cementitious paste may be formed inter alia by grouting, casting, extrusion or spraying.

In the case of use in the field of well production, the cementitious paste, after having been mixed, is conditioned at a temperature of greater than or equal to 50° C., and usually greater than or equal to 80° C. It is then formed and hardened under temperature conditions that are similar or higher, and in general typical in this field of application.

The consolidate material obtained after the cementitious paste has hardened may be used in the oil or gas extraction field or else in the building and civil engineering fields.

The subject matter of the present invention is also the use of anisotropic particles such as those that have just been described in a consolidated material obtained by the hardening of a cementitious paste comprising water and a cement comprising at least one hydraulic binder, optionally at least one filler and optionally at least one admixture; the anisotropic particle content being less than or equal to 10%, preferably less than or equal to 6%, by weight in relation to the hydraulic binder. Preferably, the minimum particle content is 1% relative to the same reference. According to a highly advantageous variant of the invention, the anisotropic particle content of the cement represents 1 to 4% by weight in relation to the weight of hydraulic binder.

These anisotropic particles are used for the purpose of lowering by at least 10%, preferably at least 20%, the Young's modulus compared with that obtained for a consolidated material containing no anisotropic particles.

Specific but nonlimiting examples of the invention will now be presented.

### EXAMPLES

Formulation:

| Formulations | | | | |
|---|---|---|---|---|
| composition | Control | | Invention | |
| Cement (*) | 784 | g | 784 | g |
| Water | 340 | g | 340 | g |
| Antifoam | 2 | g | 2 | g |
| Dispersant (**) | 5 | g | 5 | g |
| Wetting agent | 1 | g | 1 | g |
| Polyamide fiber (***) | 0 | g | 15.7 | g (2% by |
| | | | | mass/mass of cement) |

(*) Dyckerhoff G North Portland cement (see section 10 of the API (American Petroleum Institute) standards;
(**) polynaphthalene sulfonate
(***) nylon-6,6 having an elastic modulus of 3.5 GPa; dimensions: 18.1 μm (d)/3 mm (l)

Preparation of the Products:

The cement slurry was produced by mixing the productions of the control formulation according to the API Specification for Materials and Testing for Well Cements, SPEC 10, Section 5, fifth edition, Jul. 1, 1990 for both compositions.

The fibers were added as a post-addition using a blade mixer (600 revolutions per minute) for 5 minutes.

The mixes were then cast in steel molds so as to obtain test specimens having dimensions of 3×3×12 cm for carrying out the mechanical tests.

Treatment:

The molds were immersed in water for 7 days at 80° C.

Method of Evaluating the Mechanical Properties:

A three-point bending test was carried out on the test specimens with the following conditions:

distance between supports: less than 8 cm;

crosshead speed: 0.5 mm/min;

temperature of test specimen at the start of the test: 80° C.

See the figure.

Mechanical Results at 80° C.:

| Formulation | Young's modulus (MPa) |
|---|---|
| Control | 5170 |
| Invention | 3260 |

1. An oil or gas well caisson comprising a: consolidated cementitious paste comprising water and a cement, wherein the cement comprises at least one hydraulic binder, at least one filler, optionally at least one admixture, and anisotropic polyamide particles having an elastic modulus of less than or equal to 5 GPa, a glass transition temperature greater than or equal to 20° C. and a melting point greater than or equal to 100° C., said particles having a length between 1 and 5 mm and an equivalent diameter of between 1 and 150 μm, the particle content being at least 1% and less than 6% by weight relative to the weight of the hydraulic binder.

2. The caisson as claimed in claim 1, wherein the polyamide is selected from polyamides comprising at least one of the following units:
—NH—R¹—NHCO—R²—CO— (I),
—NH—R³—CO— (II),
in which formulae R¹, R² and R³, which may or may not be identical, represent:
linear or branched alkyl radicals containing 2 to 18 carbon atoms,
aryl radicals containing one or more optionally substituted aromatic rings.

3. The caisson as claimed in claim 2, wherein the radicals R¹, R² and R³, which may or may not be identical, represent linear or branched radicals containing 2 to 12 carbon atoms optionally carrying one or more methyl radicals.

4. The caisson as claimed in claim 2, wherein said radicals, which may or may not be identical, are selected from the group consisting of ethyl, 1-methylethyl, propyl, 1-methylpropyl, butyl, pentyl, hexyl, heptyl, octyl, nonyl, decyl, undecyl and lauryl divalent radicals.

5. The caisson as claimed in claim 2, wherein said radicals, which may or may not be identical, are selected from the group consisting of divalent radials comprising an aromatic ring and having free bonds in the ortho, meta or para position, or comprising several aromatic rings peri-fused together or linked via inert groups, or an alkyl radical containing 1 to 4 carbon atoms.

6. The caisson as claimed in claim 1, wherein the polyamides are selected from the group consisting of PA-4, PA-6, PA-10, PA-11, PA-12, PA-6,6, PA-4,6 and PA-6,10 polyamides, and blends or copolymers thereof.

7. The caisson as claimed in claim 1, wherein the total filler content is less than or equal to the weight of hydraulic binder.

8. The caisson as claimed in claim 1, wherein the total admixture content is less than or equal to 30% by weight in relation to the weight of hydraulic binder.

9. The caisson as claimed in claim 1, wherein the cementitious paste is prepared by contacting the hydraulic binder, the filler and optionally the admixture, with stirring, with water and then adding the anisotropic polyamide particles.

10. The caisson as claimed in claim 9, wherein the cementitious paste is conditioned and then formed by grouting, molding, casting, extrusion or spraying.

11. The caisson as claimed in claim 10, wherein the conditioning and the forming are carried out at a temperature of greater than or equal to 50° C.

12. The caisson as claimed in claim 1, wherein the cementitious paste is hardened at a temperature of greater than or equal to 50° C.

13. The caisson as claimed in claim 1, wherein the Young's modulus is lowered by at least 10% in relation to that obtained for a consolidated cementitious paste containing no anisotropic polyamide particles.

14. The oil or gas well caisson as claimed in claim 1, wherein the filler comprises a mineral filler having a particle size less than or equal to 120 μm.
